(19) United States
(12) Patent Application Publication
(10) Pub. No.: US 2021/0144202 A1
(43) Pub. Date: May 13, 2021

(54) EXTENDED PEER-TO-PEER (P2P) WITH EDGE NETWORKING

(71) Applicants: Christian Maciocco, Portland, OR (US); Trevor Cooper, Portland, OR (US); Valerie J. Parker, Portland, OR (US); Rajesh Poornachandran, Portland, OR (US); Francesc Guim Bernat, Barcelona (ES); Kshitij Arun Doshi, Tempe, AZ (US); Ned M. Smith, Beaverton, OR (US)

(72) Inventors: Christian Maciocco, Portland, OR (US); Trevor Cooper, Portland, OR (US); Valerie J. Parker, Portland, OR (US); Rajesh Poornachandran, Portland, OR (US); Francesc Guim Bernat, Barcelona (ES); Kshitij Arun Doshi, Tempe, AZ (US); Ned M. Smith, Beaverton, OR (US)

(21) Appl. No.: 17/097,117

(22) Filed: Nov. 13, 2020

(51) Int. Cl. H04L 29/08; H04L 12/26

(52) U.S. Cl. CPC H04L 67/1051; H04L 43/0817; H04L 67/16; H04L 67/306

(57) ABSTRACT

Methods, systems, and use cases for extended P2P communication with edge networking are discussed, including an edge computing device with a memory device and processing circuitry. The processing circuitry receives a request from a second edge computing device to perform a P2P exchange. A set of services for execution by the processing circuitry during the P2P exchange is determined. The processing circuitry further determines whether an enhanced edge service is available to substitute at least one service of the set of services. The enhanced edge service is associated with processing resources that are external to the edge computing device. Based on a successful determination that the enhanced edge service is available, the processing resources of the edge computing system that are external to the edge computing device are utilized to execute the enhanced edge service in place of the at least one service during the P2P exchange.

### BACKGROUND

Edge computing, at a general level, refers to the implementation, coordination, and use of computing and resources at locations closer to the “edge” or collection of “edges” of the network. The purpose of this arrangement is to reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use cases that are projected to extensively utilize edge computing include connected self-driving cars, surveillance, Internet of Things (IoT) device data analytics, video encoding and analytics, location-aware services, device sensing in Smart Cities, among many other networks and compute-intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network. Edge computing can also be used to help enhance communication between user devices or between IoT devices.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing;

FIG. 2 illustrates operational layers among endpoints, an edge cloud, and cloud computing environments;

FIG. 3 illustrates an example approach for networking and services in an edge computing system;

FIG. 4 illustrates deployment of a virtual edge configuration in an edge computing system operated among multiple edge nodes and multiple tenants;

FIG. 5 illustrates various compute arrangements deploying containers in an edge computing system;

FIG. 6 illustrates a compute and communication use case involving mobile access to applications in an edge computing system;

FIG. 7A provides an overview of example components for compute deployed at a compute node in an edge computing system;

FIG. 7B provides a further overview of example components within a computing device in an edge computing system;

FIG. 8 illustrates a block diagram of an Edge-as-a-Service (EaaS) architecture using a P2P communications manager performing P2P enhancement functions, according to an example embodiment;

FIG. 9 illustrates a system in which extended P2P communication occurs in accordance with some embodiments;

FIG. 10 illustrates a comparison between traditional and extended P2P communication in accordance with some embodiments;

FIG. 11 illustrates a block diagram of an example P2P communications manager in accordance with some embodiments;

FIG. 12 illustrates a flowchart of a method for provisioning extended P2P services using P2P enhancement functions in accordance with some embodiments; and

FIG. 13 illustrates a flowchart of another method for provisioning extended P2P services using P2P enhancement functions in accordance with some embodiments.

### DETAILED DESCRIPTION

The following embodiments generally relate to peer-to-peer (P2P) enhancement functions to facilitate P2P exchanges in a distributed edge computing environment. In example embodiments, the P2P enhancement functions facilitate the use of edge network capabilities to enhance the capabilities and performance of P2P exchanges between end nodes including end-user devices, IoT devices, or other types of computing devices (e.g., sensor devices, laptops, base stations such as next generation or enhanced Node-Bs, user equipment, smartphones, etc.). The network edges, being physically close to the end nodes, can be configured to offer P2P enhancements functions such as functions associated with generic or specialized edge services (e.g. compute services, acceleration services, caching/storage services, encryption/decryption services, and other services) to end nodes, extending the P2P concept by inserting the edge network services as a “party” or proxy in the P2P exchange.

In some aspects, a P2P communications manager (e.g., an edge orchestration device or another type of management device) can perform the P2P enhancement functions, which include obtaining information from edge computing devices (e.g., edge devices within one or more edges) on available device resources that can be used for performing different services (e.g., hardware or software resources associated with compute, acceleration, caching/storage, encryption/decryption, and other services). The P2P enhancement functions performed by the P2P communications manager further include obtaining information from the edge computing devices on resource usage restrictions (e.g., specific time(s) the corresponding resources are available for use, resource usage subscription requirements, data privacy restrictions, etc.). In this regard, end nodes according to embodiments can partition compute resources (e.g., CPU, GPU, FPGA, SmartNIC, programmable switches, etc.), accelerators, caching/storage, and other resources with the edge network to enhance end node performance, capacity, and capabilities. Resources offered by the edge network can be discovered through an advertisement protocol and/or looked up through other mechanisms including, for example, the mechanisms used in Information Centric Networks (ICNs) or using the Domain Name System (DNS).

Systems according to embodiments extend the concepts of Named-Data-Networks (NDN) and ICNs by providing computing and storage services that can be registered, discovered, and accessed in a way similar to how cached content is accessed in NDNs and ICNs. End nodes can operate in a default mode of operation that can be extended dynamically to take advantage of additional services offered by edge nodes when communicating with peer devices. Besides enhancing end devices capabilities in a P2P exchange, or any additional exchange, such capabilities could incite edge network providers, communication service providers, or cloud service providers, to propose significant compute/caching/storage capabilities at the edges for these end nodes to use them as part of their processing path. Example embodiments can be implemented in systems similar to those shown in any of the systems described below in reference to FIGS. 1-7B. Additional description of P2P enhancement functions and a P2P communications manager in connection with an edge architecture and edge computing devices is provided hereinbelow in connection with at least FIG. 8-FIG. 13.

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power are often constrained. Thus, edge computing attempts to reduce the number of resources needed for network services, through the distribution of more resources which are located closer both geographically and in-network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their infrastructures. These include a variety of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use cases (e.g., autonomous driving or video surveillance) for connected client devices. Or as an example, base stations may be augmented with compute and acceleration resources to directly process service workloads for the connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In some aspects, the edge cloud 110 and the cloud data center 130 can be configured with peer-to-peer enhancement functions (P2PEF) 111. For example, network management entities within the edge cloud 110 and the cloud data center 130 can be configured with a P2P communications manager performing the P2PEF to facilitate P2P exchanges in a distributed edge computing environment. In some embodiments, the P2PEF include obtaining information from edge computing devices (e.g., edge devices within one or more edges) on available device resources for enhancing edge services (e.g., hardware or software resources which are available for use within the edge in connection with enhanced edge services such as compute services, acceleration services, caching/storage services, encryption/decryption services, and other services). The P2PEF further include obtaining information from the edge computing devices on resource usage restrictions associated with the available resources (e.g., specific time(s) the corresponding resources are available for use, resource usage subscription requirements, data privacy restrictions, etc.). In some embodiments, the P2PEF further include configuring access credentials for use by one or more edge computing devices within a P2P exchange to access enhanced edge services. In this regard, an edge computing device (including an end node) can substitute the execution of one or more services of a P2P application by accessing one or more enhanced edge services performed on resources that are external to the edge computing device. Additional functionalities and techniques associated with P2PEF and a P2P communications manager performing P2PEF are discussed in connection with FIG. 8-FIG. 13.

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted. Any of the communication use cases 205 can be configured based on P2PEF 111, which may be performed by a P2P communications manager as discussed in connection with FIG. 8-FIG. 13.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, a number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of (a) Priority (throughput or latency; also referred to as service level objective or SLO) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, whereas some other input streams may tolerate an occasional failure, depending on the application); and (c) Physical constraints (e.g., power, cooling, and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real-time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource-constrained and therefore there is pressure on the usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permission access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from the client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, the cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or another thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 110 may be servers, multi-tenant servers, appliance computing devices, and/or any other type of computing device. For example, the edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect the contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein, and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent of other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code, or scripts may execute while being isolated from one or more other applications, software, code, or scripts.

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure. In an example embodiment, the edge cloud 110 and the cloud or data center 360 utilize P2PEF 111 in connection with disclosed techniques. The P2P enhancement functions may be performed by at least one P2P communications manager as discussed in connection with FIG. 8-FIG. 13.

FIG. 4 illustrates deployment and orchestration for virtual edge configurations across an edge computing system operated among multiple edge nodes and multiple tenants. Specifically, FIG. 4 depicts the coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 (or virtual edges) provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers the first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460. In an example embodiment, the edge provisioning functions 450 and the orchestration functions 460 can utilize P2P enhancement functions 111 in connection with disclosed techniques. The P2P enhancement functions 111 may be performed by a P2P communications manager as discussed in connection with FIG. 8-FIG. 13.

It should be understood that some of the devices in the various client endpoints 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant-specific RoT. An RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in virtual edge instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshaling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain an RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support an RoT context for each. Accordingly, the respective RoTs spanning devices in 410, 422, and 440 may coordinate the establishment of a distributed trusted computing base (DTCB) such that a tenant-specific virtual trusted secure channel linking all elements end to end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency-sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents the assignment of resources until the right tenant authenticates or prevents provisioning of data or a workload to a container until an attestation result is satisfied.

Also, with the use of container pods, tenant boundaries can still exist but in the context of each pod of containers. If each tenant-specific pod has a tenant-specific pod controller, there will be a shared pod controller that consolidates resource allocation requests to avoid typical resource starvation situations. Further controls may be provided to ensure the attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked before the second pod executing.

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510) or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside from the execution of virtualized network functions). This arrangement is further adapted for use in system arrangement 540, which provides containers 542, 543, or execution of the various functions, applications, and functions on compute nodes 544, as coordinated by a container-based orchestration system 541.

The system arrangements depicted in FIG. 5 provide an architecture that treats VMs, Containers, and Functions equally in terms of application composition (and resulting applications are combinations of these three ingredients). Each ingredient may involve the use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves, and hardware partitioning schemes may be used by edge owners to enforce tenancy. Other isolation environments may include bare metal (dedicated) equipment, virtual machines, containers, virtual machines on containers, or combinations thereof.

In further examples, aspects of software-defined or controlled silicon hardware, and other configurable hardware, may integrate with the applications, functions, and services of an edge computing system. Software-defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles that communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances, or components located at or in a communication base station 642 (e.g., a base station of a cellular network). As discussed above, the respective edge resource nodes 640 include an amount of processing and storage capabilities, and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location, or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicates with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or a pod of containers) may be flexibly migrated from an edge node 620 to other edge nodes (e.g., 620, 640, etc.) such that the container with an application and workload does not need to be reconstituted, re-compiled, re-interpreted for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container-native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In an example embodiment, the edge cloud 110 utilizes P2P enhancement functions 111 in connection with disclosed techniques. The P2P enhancement functions may be performed by at least one P2P communications manager (e.g., as present within the edge resource node 640, the edge gateway node 620, and the core data center 650), as discussed in connection with FIG. 8-FIG. 13.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application that may be provided by a third party) is executed. The container may be any isolated-execution entity such as a process, a Docker or Kubemetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer-readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer-readable instructions 782 of FIG. 7B. The receiving parties may be consumers, service providers, users, retailers, OEMs, etc., who purchase and/or license the software instructions for use and/or re-sale and/or sub-licensing.

In an example, the edge provisioning node 644 includes one or more servers and one or more storage devices. The storage devices host computer-readable instructions such as the example computer-readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer-readable instructions 782 from the edge provisioning node 644. For example, the software instructions, which may correspond to the example computer-readable instructions 782 of FIG. 7B may be downloaded to the example processor platform/s, which is to execute the computer-readable instructions 782 to implement the methods described herein.

In some examples, the processor platform(s) that execute the computer-readable instructions 782 can be physically located in different geographic locations, legal jurisdictions, etc. In some examples, one or more servers of the edge provisioning node 644 periodically offer, transmit, and/or force updates to the software instructions (e.g., the example computer-readable instructions 782 of FIG. 7B) to ensure improvements, patches, updates, etc. are distributed and applied to the software instructions implemented at the end-user devices. In some examples, different components of the computer-readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edges, networking, or endpoint components. For example, an edge compute device may be embodied as a personal computer, a server, a smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application-specific integrated circuit (ASIC), reconfigurable hardware or hardware circuitry, or other specialized hardware to facilitate the performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within a SOC or integrated with networking circuitry (e.g., in a SmartNIC, or enhanced SmartNIC), acceleration circuitry, storage devices, or AI hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized accelerators such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte-addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of device configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processors, such as a Quark™, an Atom™, an i3, an i5, an i7, an i9, or an MCU-class processor, or another such processor available from Intel®. However, any number of other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) per a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 758 may also couple to the processor 752 via the interconnect 756. In an example, storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications under the Institute of Electrical and Electronics Engineers (IEEE) 802.11 standard. Also, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area. (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPLs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service, or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium-ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application-specific integrated circuit (ASIC).

Also in a specific example, the instructions 782 on the processor 752 (separately, or in combination with the instructions 782 of the machine-readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through the use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in device 750 through the TEE 790 and the processor 752.

In an example, the instructions 782 provided via memory 754, the storage 758, or the processor 752 may be embodied as a non transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that is capable of storing, encoding, or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of several transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Extended P2P with Edge Networking

The edge network node(s) being physically closer to the end-user or IoT devices and having the ability to host generic or specialized computation, caching, and storage resources could enhance edge computing devices (including end devices or end nodes) capabilities and processing capacity. These services in the edge node could also now be part of the device-to-device (D2D) or peer-to-peer (P2P) communication as a device endpoints acting as a hierarchical generic or specialized compute, cache or storage, etc. The disclosed techniques extend the P2P concept to include concepts similar to Named-Data-Networks (NDN) or Information-Centric-Networks (ICN) in which content can be cached and positioned on NDN nodes close to the requesting devices. In some embodiments, an edge computing device can provide not only cached content but also any computing or storage services, where NDN or ICN-like capabilities can be used to discover and register for these services in a traditional P2P or D2D network. Additionally, in some embodiments, a hierarchy of edge service(s) insertion can be accommodated, e.g., IoT Edge, Network Near, and Far Edges with 5G type of E2E deployment in terms of dynamic discovery, compute, and storage offload. In the case of mobile edge devices (e.g. autonomous vehicles), the disclosed techniques allow for efficient hand-off with orchestration capability across the hierarchy of edge devices with general/specialized accelerators. In some aspects, the edge node(s) availability and dynamic handoff of IoT devices may be exposed to orchestrators or other management devices via NDN/ICN P2P for efficient infrastructure and resource planning/scalability.

Systems according to embodiments extend the capabilities of end devices in a P2P exchange, or any other client-server exchange, by making use of service provided by edge networks close to the end devices to enhance end device capabilities and performance. The network edges, being physically close to the end nodes, can be configured to offer P2P enhancements functions such as functions associated with generic or specialized edge services (e.g. compute services, acceleration services, caching/storage services, streaming services such as high definition (HD) (or higher definition) streaming services, encryption/decryption services, and other services) to end nodes, extending the P2P concept by inserting the edge network services as a “party” or proxy in the P2P exchange.

Other examples of P2P enhanced functions or services may include dynamic translation from one language to another through richer artificial intelligence (AI) capabilities, annotation of content as an assistive service for someone with visual or auditory handicaps, automatic filtering (using AI) of any inappropriate content (with the consent of one or both of the communicating parties), and in general, limited by the available resources at the edge, and prior agreements among cooperating parties in the use of any sequestered resources at either party. For non-real-time critical services, such proxying can also include other, more resource-intensive operations on information such as deeper filtering for viruses. In the cases of higher definition streaming or transfer of large format images a “provider” could as mentioned above provide real-time annotation, creation, and insertion of metadata to enabling querying the video stream later and so forth, which can be added.

In some aspects, interruptions in enhanced services can be addressed using disclosed techniques. For example, the underlying non-enhanced version of the service may remain available and can be used automatically (e.g., when the enhanced service becomes unavailable). In this regard, edge resources are not limited to only the resources immediately available at the very first hop between the communicating parties. That is, other resources from other edge nodes can be marshaled if interruptions are due to inadequate resources. But if the interruptions are unavoidable, for example, due to congested communications (oversubscribed transport paths) then a decision to fall back to lower quality or lower performance can be made by the proxying intermediary. Other alternatives are possible, for example, one or both of the parties in communication may have prior arrangements with the edge services provider to switch seamlessly to a higher cost (premium) service partition offered by an edge services provider or by a third party such as coloration party that offers such enhanced intermediation at the higher cost. In some aspects, the basic enhanced service will always run assuming the source does not crash and is not interrupted. For example, assuming that the basic service provides some video encoding of a live stream, then services provided in the edge could be enhancements of this video stream, e.g. providing effects, fine-tuning of the video, etc. If the enhanced services fail, processing using the original video stream quality may resume.

In some aspects, a P2P communications manager (e.g., an edge orchestration device or another type of management device) can perform the P2P enhancement functions, which include obtaining information from edge computing devices (e.g., edge devices within one or more edges) on available device resources (e.g., hardware or software resources associated with compute, acceleration, caching/storage, encryption/decryption, and other services). In this regard, P2P or client/server communication can be extended by introducing the use of edge network services, physically close to the end devices and within the data communication path, allowing the end devices to partition their workloads to make use of these services and to make use of additional processing power, additional caching or storage, during P2P communications. This enables the devices to use edge network services to improve the P2P experience by inserting these services in the processing chain and the communication path.

FIG. 8 illustrates a block diagram of an Edge-as-a-Service (EaaS) architecture using a P2P communications manager performing P2P enhancement functions, according to an example embodiment. A more detailed diagram of a P2P communications manager is illustrated in connection with FIG. 11. The EaaS architecture 800 includes client compute nodes 802, 804, . . . , 806 communicating with a plurality of edge devices (or nodes) operating as part of node clusters in different edge layers as illustrated in FIG. 2. For example, node cluster 808 includes edge devices associated with an edge devices layer 200. Node cluster 810 includes edge devices associated with a network access layer 220, and node cluster 812 includes edge devices associated with a core network layer 230. A core server (e.g., a server associated with a core data center) may be part of the node cluster 812. The global network cloud 814 may be located at a cloud data center layer 240.

Although an illustrative number of client compute nodes 802, 804, . . . , 806, edge devices in node clusters 808, 810, 812, and a global network cloud 814 are shown in FIG. 8, it should be appreciated that the EaaS architecture 800 may include more or fewer components, devices, or systems at each layer. Additionally, the number of components of each layer (e.g., the layers of node clusters 808, 810, and 812) may increase at each lower level (i.e., when moving closer to endpoints).

Consistent with the examples provided herein, each of the client compute nodes 802, 804, . . . , 806 may be embodied as any type of endpoint component, device, appliance, or “thing” capable of communicating as a producer or consumer of data. Further, the label “node” or “device” as used in the EaaS architecture 800 does not necessarily mean that such node or device operates in a client (primary) role or another (secondary) role; rather, any of the nodes or devices in the EaaS architecture 800 refer to individual entities, nodes, or subsystems which include discrete or connected hardware or software configurations to facilitate or use the edge cloud 110. The client compute nodes 802, 804, . . . , 806 can include computing devices at an endpoint (devices and things) layer, which accesses the node clusters 808, 810, 812 to conduct data creation, analysis, and data consumption activities.

In an example embodiment, the EaaS architecture 800 can include at least one P2P communications manager 816 configured to perform P2P enhancement functions 111 in connection with disclosed techniques. The P2P enhancement functions may be performed by the at least one P2P communications manager as configured within one or more management nodes (e.g., an edge orchestrator node or a meta-orchestrator node within any of the node clusters 808-812) and/or within one or more connectivity nodes (e.g., an edge connectivity node within any of the node clusters 808-812). In some embodiments, the P2P communications manager 816 is configured as an intermediary node connecting a data requesting/processing node and a data source node, or two nodes (e.g., end nodes) within a P2P exchange (e.g., each node may be executing a P2P application such as a video chat application, a gaming application, etc.). The nodes associated with the P2P exchange may be nodes within the EaaS architecture 800.

FIG. 9 illustrates a system 900 in which extended P2P communication occurs in accordance with some embodiments. The system 900 includes core and data center network (CDCN) 902 and edge networks 904 and 906. A first edge computing device 908 (e.g., an end node or a user device) is located in the edge network 904 and a second edge computing device 910 (e.g., an end node or a user device) is located in the edge network 906.

The system 900 can support traditional client/server communications 924 between the first edge computing device 908 and CDCN 902. The system 900 can also support traditional P2P communications 926 such as, e.g., between the first edge computing device 908 and the second edge computing device 910. Embodiments discussed herein extend P2P or client/server communication by introducing the use of enhanced edge services 930 and 932 physically close to the end devices (e.g., edge computing devices 908 and 910), allowing the end devices to partition their workloads to make use of these services (e.g., to make use of additional processing power, additional caching or storage, in middle of communication, etc.). This enables the edge computing devices 908 and 910 to use enhanced edge services to improve the P2P experience by inserting these services in the processing chain and the communication path.

The enhanced edge services 930 within edge network 904 include a caching/storage service 912, a compute service 914, and an acceleration service 916. The enhanced edge services 932 within edge network 906 include a caching/storage service 918, a compute service 920, and an acceleration service 922. Even though enhanced edge services 930 and 932 are illustrated to include three types of services, the disclosure is not limited in this regard and other types of services (e.g., encryption/decryption) may be used.

As used herein, the term “enhanced edge services” refers to services that can be provided using hardware or software resources of edge computing devices within an edge network, where such services satisfy one or more preconfigured performance indicators e.g., CPU processing power, memory bandwidth, memory availability, etc.). In some aspects, a P2P communications manager can set the minimum performance indicators and compile a P2P registry of edge services to include services that satisfy the minimum performance indicators. In this regard, when an edge computing device uses one of the enhanced edge services (executed using resources of one or more other edge computing devices) to substitute a service (executed using its resources) that is associated with a lower performance indicator, the edge computing device will benefit from using the enhanced edge service instead of its service.

FIG. 10 illustrates a comparison between traditional and extended P2P communication in accordance with some embodiments. In the top half of FIG. 10, a traditional P2P communication 1000 is illustrated, while the bottom half of FIG. 10 illustrates an extended P2P communication 1050.

The traditional P2P communication 1000 takes place between a first edge computing device 1006 in edge network 1002 and a second edge computing device 1008 in edge network 1004 via a P2P communication link 1012. The edge computing device (e.g., a user device) 1008 includes services (e.g., Svc-1 through Svc-4) which can be provided by an application 1010 (e.g., a P2P application) executing on the device 1008 using the device resources (e.g., hardware and software resources). As illustrated in FIG. 10, no enhanced edge services are provided in the traditional P2P communication 1000.

The extended P2P communication 1050 illustrated in the bottom half of FIG. 10, takes place between a first edge computing device 1056 in edge network 1052 and a second edge computing device 1058 in edge network 1054 via a P2P communication link 1070. The edge computing device (e.g., a user device) 1056 includes services (e.g., Svc-1 through Svc-4) which can be provided by an application 1072 (e.g., a P2P application) executing on the device 1056 using the device resources (e.g., hardware and software resources).

In the extended P2P communication 1050, in addition to services provided by the edge computing device 1056, enhanced edge services 1062 are provided within the edge network 1052 as well. The enhanced edge services 1062 can include a caching/storage service 1068, a compute service 1064, and an acceleration service 1066,

In some embodiments, a P2P communications manager 1076 (which is the same as the manager 816) can be used to configure the use of the enhanced edge services 1062 in connection with the extended. P2P communication 1050. More specifically, the P2P communications manager 1076 can configure a P2P registry 1060 of enhanced edge services 1062, and allow access to one or more of the enhanced edge services to edge computing devices for use during a P2P exchange (e.g., the P2P exchange using P2P communication link 1070), Additional details of the P2P communications manager 1076 are provided hereinbelow in connection with FIG. 11.

In some aspects, the enhanced edge services provided by the edge network 1052 could be registered and discovered (e.g., by the P2P communications manager 1076) using any type of advertisement protocol, or by name using a Domain Name System (DNS) or an Information Centric Network/Content Centric Network (ICN/CCN) mechanism. In this regard, the P2P registry 1060 can be configured by the P2P communications manager 1076 by querying qualified requesters (e.g., edge computing devices within the edge network 1052 and other networks such as edge network 1054). In some aspects, the P2P communications manager 1076 can further indicate (e.g., as part of the P2P registry 1060) which edge computing device (or devices) within the edge network 1052 (or one or more other networks) can perform one or more of the enhanced edge services 1062. ICNs are often overlays on top of existing Edge IoT architectures and therefore, ICN/Named-Data-Networks (NDN) are related to north-south and east-west optimization strategies due to inherent properties of underlying physical deployments in Edge architectures. NDN/ICN expect a portion of the data (metadata) will be contributed to the NDN/ICN routing nodes to facilitate discovery and routing.

In an example, P2P communication exchange using enhanced edge services 1062, the first edge computing device 1056 receives a request from the second edge computing device 1058 via the P2P communication link 1070 to perform a P2P exchange. To perform the P2P exchange, the first edge computing device 1056 selects a P2P application 1072 for execution. The P2P application 1072 can be, for example, a messaging application, a gaming application, or a video chat application. The first edge computing device 1056 determines a set of services (e.g., Svc-1-Svc-4) that are part of the P2P application 1072, for execution during the P2P exchange with the second edge computing device 1058. The first edge computing device 1056 determines whether an enhanced edge service (e.g., one of the enhanced edge services 1062) is available to substitute at least one service of the set of services, where the enhanced edge service is associated with processing resources (e.g., hardware or software) of the edge network 1052 that are external to the edge computing device 1056. For example, the first edge computing device 1056 determines that enhanced edge service 1074 (including services Svc-2′ and Svc-2″) can be executed (using resources of another edge computing device) in place of Svc-2 of P2P application 1072. Therefore, based on a successful determination that the enhanced edge service is available, the first edge computing device 1056 utilizes the processing resources of the edge network 1052 that are external to the edge computing device 1056 to execute the enhanced edge service 1074 in place of the at least one service (e.g., Svc-2) during the P2P exchange.

In some aspects, the first edge computing device 1056 determines (e.g., based on notification by the P2P communications manager 1076) that the enhanced edge service 1074 is available and provided by one or more edge computing devices (e.g., as identified in the P2P registry 1060 or by the P2P communications manager 1076). In some aspects, a boost of resources in connection with execution of an enhanced edge service from the same edge node or one or more neighboring edge nodes may be used. In some aspects, multiple edge nodes (resources) may transact in providing peer-to-peer communication proxying service, and thus participate in a dynamic load balancing, if the resources (computational/storage/power) at one edge node are insufficient for supporting enhanced services (including, but not limited to high definition streaming services). In this regard, multiple service providers (or a single provider) at the edge can be configured to perform an enhanced service, which can act either to load balance or scale up what the provider can support, or provide fault tolerance for the service, i.e., if one provider fails another one takes over.

In some aspects, each service of the set of services executed by the first edge computing device 1056 is associated with a performance indicator when executed by the processing circuitry of the edge computing device. To determine the enhanced edge service is available, the first edge computing device 1056 can access the P2P registry 1060 of enhanced edge services associated with the processing resources of the edge network 1052 that are external to the edge computing device. For example, such access to the P2P registry 1060 can be provided to all edge computing devices within the edge network 1052, which can be selectively provided based on subscription or can be provided via a query to the P2P communications manager 1076. After accessing the P2P registry 1060, the edge computing device 1056 can determine if any of the available enhanced edge services match the services associated with the P2P application 1072. Additionally, the edge computing device 1056 can retrieve from the P2P registry, a performance indicator for any matching enhanced edge services, and select an enhanced edge service to substitute the at least one service of the set of services based on a comparison of the performance indicator for the at least one service of the P2P application 1072 with the performance indicator for the matching enhanced edge service. When multiple enhanced edge services match services of the P2P application 1072, then the edge computing device 1056 can select the enhanced edge service (or services) that have higher performance indicators than a corresponding service of the P2P application 1072 when executed by device 1056.

In some aspects, each of the performance indicators for the set of services is indicative of utilization of compute resources, storage resources, or acceleration resources of the edge computing device 1056 during the execution of a corresponding service of the set of services. Similarly, each of the performance indicators for the enhanced edge services 1062 is indicative of utilization of compute resources, storage resources, or acceleration resources of the edge network (e.g., edge network 1052) that are external to the edge computing device 1056, during the execution of a corresponding service of the enhanced edge services.

In some aspects, the edge computing device 1056 performs a secure exchange with the P2P communications manager 1076 to obtain access credentials associated with the enhanced edge service 1074 selected from the P2P registry 1060 of enhanced edge services. The edge computing device 1056 utilizes the access credentials to access the processing resources that are external to the edge computing device to execute the enhanced edge service in place of at least one service during the P2P exchange. The processing resources that are external to the edge computing device 1056 can be hardware resources and software resources of an edge orchestration device or one or more other edge computing devices that are not participating in the P2P exchange via the P2P communication link 1070.

FIG. 11 illustrates a block diagram of the P2P communications manager 1076 in accordance with some embodiments. Referring to FIG. 11, the P2P communications manager 1076 can include a P2P registry 1102 of enhanced edge services, resource usage restrictions 1116, access credentials generating circuitry 1124, and network communication circuitry 1130.

The P2P communications manager 1076 can query multiple edge computing devices within an edge computing system and obtain resource availability information to configure the P2P registry 1102 (which can be the same as P2P registry 1060). The P2P registry 1102 includes storage services information 1104, compute services formation 1106, acceleration services information 1108, encryption/decryption services information 1110, and information on other services 1112. Each information on a specific service can include hosting device information which provides such service, specific hardware or software resource identification information used to provide such service, device addressing information, or other security credentials information for accessing the device to use the service.

The P2P registry 1102 further includes performance indicators 1114 for each of the services within the registry. Such performance indicators can be determined by each device providing the enhanced edge service and reported to the P2P communications manager 1076 for storage in the P2P registry 1102. When the performance indicators are reported by the edge computing devices providing the enhanced edge services, additional information such as the resource usage restrictions 1116 can also be reported. The resource usage restrictions 1116 can include time restrictions 1118 (e.g., the enhanced edge service is available only at specific times), subscription requirements 1120 (e.g., when the enhanced edge service is a for-fee service), and data privacy restrictions 1122 (e.g., only certain types of data can be processed using the enhanced edge service or the enhanced edge service only processes data with a minimum threshold of privacy protection mechanisms). To reduce privacy violations, embodiments provide multiple layers to the ICN/NDN routing layer, with access to some layers (e.g., lower layers) protected using, for example, group credentials or semi-permissioned networks.

The resource usage restrictions 1116 can be further supplemented by restrictions that are configured by the P2P communications manager 1076 dynamically or based on global resource availability within the edge network.

The access credentials generating circuitry 1124 is configured to generate access credentials 1126, . . . , 1128 which can be provided to edge computing devices to access an enhanced edge service from the P2P registry 1102. The network communication circuitry 1130 is used to communicate with edge computing devices within multiple edge networks.

In an example operation of the P2P communications manager 1076, resource availability information for processing resources of a plurality of edge computing devices operable in an edge computing system (e.g., including edge networks 1052 and 1054) is obtained. Based on the resource availability information, the P2P communications manager 1076 generates the P2P registry 1060 of enhanced edge services that can be performed during a P2P exchange using the processing resources of the plurality edge computing devices. The P2P communications manager 1076 detects an edge computing device (e.g., 1056) is executing a P2P application 1072 associated with a set of services (e.g., Svc-1-Svc-4). For example, the P2P communications manager 1076 can receive a request for an enhanced edge service from the edge computing device 1056, or the P2P communications manager 1076 can detect the initiation of the P2P exchange and launching of the P2P application 1072.

The P2P communications manager 1076 selects an enhanced edge service from the enhanced edge services in the P2P registry 1060 to substitute at least one service of the set of services during the executing of the P2P application. In some aspects, the P2P communications manager 1076 is aware of the execution of the P2P application 1072 and its services, and can automatically review the P2P registry and select a suitable enhanced edge service to substitute (and prevent) a service of the P2P application from execution on the device 1056 (e.g., based on a comparison of performance indicators). In some aspects, the P2P communications manager 1076 can provide the device 1056 access to the P2P registry and assist the device with the selection of the enhanced edge service (e.g., as described above in connection with FIG. 10).

In embodiments, higher layer routing nodes contain privacy-sanitized metadata, giving the appearance of the network being less rich. Data producers and consumers can authenticate with an increasingly narrow list of participants to reveal richer data sets.

In some embodiments, improved security for P2P and D2D cooperative or participative operations is provided by implementing mechanisms for sequestering resources used for P2P sharing into a separate edge-wide domain. In embodiments, each device or computational peer (e.g., device 1056 or device 1058) implements a partition into which an edge-wide super-domain is granted the resources that the edge-wide super domain may use to perform the participative operations without allowing data to be exposed to the donor of those resources. Such a capability may be implemented by a sequestration code in a supervisory layer using a mechanism similar to hot-plug mechanisms (e.g., when memory or a CPU is removed or re-introduced into a running machine). As such, resources can be donated/received to enclaves logically separate from the host, including enclaves physically within the host.

In embodiments, layering can be stratified according to a mandatory access policy (MAC) such as Bell-LaPadula (e.g., unclassified, classified, secret, top-secret) so that a top layer contains only unclassified metadata and data. Likewise, a bottom layer can contain top-secret metadata and data. The NDN/ICN abstraction is mapped to Edge systems that implement multi-layer security. For example, an SELinux security module may implement a Bell-LaPadula security model. Intel SGX enclaves may be scheduled for use by the OS where a different enclave handles non-overlapping MAC compartments and VMM may partition memory, CPU, and/or I/O according to MAC layers.

FIG. 12 illustrates a flowchart of method 1200 for provisioning extended P2P services using P2P enhancement functions in accordance with some embodiments. Referring to FIG. 12, at operation 1202, the edge computing device 1056 determines whether credentials are available for querying for enhanced edge services (e.g., querying the P2P communications manager 1076). If credentials are not available, at operation 1206, the edge computing device 1056 executes the P2P application 1072 without an enhanced edge service. If credentials are available, processing continues with operation 1204 when it is determined whether the edge network 1052 offers enhanced edge services. If no enhanced edge services are provided, processing continues with operation 1206. If enhanced edge services are available, processing continues with operation 1208, when device 1056 queries the P2P registry 1060 (or requests access to the P2P registry from the P2P communications manager 1076).

At operation 1210, a determination is made on whether an enhanced edge service is available (e.g., by device 1056 or the P2P communications manager 1076). If an enhanced edge service is not available, processing continues with operation 1206. If an enhanced edge service is available, processing continues with operation 1212 when it is determined whether connectivity to the enhanced edge service and insertion to the service is available. If connectivity to the enhanced edge service is not available, processing continues with operation 1206. If connectivity to the enhanced edge service is available, the enhanced edge service is executed at operation 1214. At operation 1216, a determination is made on whether the enhanced edge service execution is complete. When it is complete, processing continues with operation 1218 when the edge resources used for the execution of the enhanced edge service are released by device 1056.

FIG. 13 illustrates a flowchart of another method 1300 for provisioning extended P2P services using P2P enhancement functions in accordance with some embodiments. Referring to FIG. 13, at operation 1302, a request from a second edge computing device to perform a P2P exchange is received at a first edge computing device. For example, the first edge computing device 1056 receives a request from the second edge computing device 1058 via the P2P communication link 1070 to perform a P2P exchange. To perform the P2P exchange, the first edge computing device 1056 selects a P2P application 1072 for execution. The P2P application 1072 can be, for example, a messaging application, a gaming application, or a video chat application.

At operation 1304, a set of services for execution by the processing circuitry during the P2P exchange with the second edge computing device is determined. For example, the first edge computing device 1056 determines a set of services (e.g., Svc-1-Svc-4) that are part of the P2P application 1072, for execution during the P2P exchange with the second edge computing device 1058.

At operation 1306, a determination is made on whether an enhanced edge service is available to substitute at least one service of the set of services. The enhanced edge service is associated with processing resources of the edge computing system that are external to the edge computing device. For example, the first edge computing device 1056 determines whether an enhanced edge service (e.g., one of the enhanced edge services 1062) is available to substitute at least one service of the set of services, where the enhanced edge service is associated with processing resources (e.g., hardware or software) of the edge network 1052 that are external to the edge computing device 1056. For example, the first edge computing device 1056 determines that enhanced edge services 1074 (including services Svc-2′ and Svc-2″) can be executed (using resources of another edge computing device) in place of Svc-2 of P2P application 1072.

At operation 1308, based on a successful determination that the enhanced edge service is available, the processing resources of the edge computing system that are external to the edge computing device are used to execute the enhanced edge service in place of at least one service during the P2P exchange. For example, based on a successful determination that the enhanced edge service is available, the first edge computing device 1056 utilizes the processing resources of the edge network 1052 that are external to the edge computing device 1056 to execute the enhanced edge service 1074 in place of the at least one service (e.g., Svc-2) during the P2P exchange.

It should be understood that the functional units or capabilities described in this specification may have been referred to or labeled as components, circuits, or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

### Additional Examples and Aspects

Example 1 is an edge computing device operable in an edge computing system, the edge computing device including network communications circuitry (NCC); a memory device; and processing circuitry coupled to the NCC and the memory device, the processing circuitry configured to: receive a request from a second edge computing device via the NCC, to perform a peer-to-peer (P2P) exchange; determine a set of services for execution by the processing circuitry during the P2P exchange with the second edge computing device; determine whether an enhanced edge service is available to substitute at least one service of the set of services, the enhanced edge service associated with processing resources of the edge computing system that are external to the edge computing device; and based on a successful determination that the enhanced edge service is available, utilize the processing resources of the edge computing system that are external to the edge computing device to execute the enhanced edge service in place of the at least one service during the P2P exchange.

In Example 2, the subject matter of Example 1 includes, P application is one of a messaging application; a gaming application; and a video chat application.

In Example 3, the subject matter of Examples 1-2 includes subject matter where the set of services includes one or more of a compute service; an acceleration service; a caching/storage service; a high definition (HD) streaming service; and an encryption/decryption service.

In Example 4, the subject matter of Examples 1-3 includes subject matter where each service of the set of services is associated with a performance indicator when executed by the processing circuitry of the edge computing device.

In Example 5, the subject matter of Example 4 includes subject matter where to determine the enhanced edge service is available, the processing circuitry is configured to: access a P2P registry of a plurality of enhanced edge services associated with the processing resources of the edge computing system that are external to the edge computing device, the P2P registry maintained by an edge orchestration device.

In Example 6, the subject matter of Example 5 includes subject matter where to determine the enhanced edge service is available, the processing circuitry is configured to retrieve from the P2P registry, a performance indicator for each of the plurality of enhanced edge services; and select the enhanced edge service from the plurality of enhanced edge services to substitute the at least one service of the set of services based on a comparison of the performance indicators for the set of services with the performance indicators for the plurality of enhanced edge services.

In Example 7, the subject matter of Example 6 includes subject matter where each of the performance indicators for the set of services is indicative of utilization of compute resources, storage resources, or acceleration resources of the edge computing device during execution of a corresponding service of the set of services.

In Example 8, the subject matter of Examples 6-7 includes subject matter where each of the performance indicators for the plurality of enhanced edge services is indicative of utilization of compute resources, storage resources, or acceleration resources of the edge computing system that are external to the edge computing device, during execution of a corresponding service of the plurality of enhanced edge services.

In Example 9, the subject matter of Examples 6-8 includes subject matter where the processing circuitry is configured to perform a secure exchange with the edge orchestration device via the NCC to obtain access credentials associated with the enhanced edge service selected from the plurality of enhanced edge services.

In Example 10, the subject matter of Example 9 includes subject matter where the processing circuitry is configured to: utilize the access credentials to access the processing resources of the edge computing system that are external to the edge computing device to execute the enhanced edge service in place of the at least one service during the P2P exchange.

In Example 11, the subject matter of Example 10 includes subject matter where the processing resources of the edge computing system that are external to the edge computing device are at least one of hardware resources and software resources of the edge orchestration device or a third edge computing device within the edge computing system.

Example 12 is an orchestration system comprising: a plurality of hardware components, including a processing circuitry, network communications circuitry, and access credentials generating circuitry; and at least one memory device including instructions embodied thereon, wherein the instructions, which when executed by the processing circuitry, configure the hardware components to perform operations to: obtain resource availability information for processing resources of a plurality of edge computing devices operable in an edge computing system; generate, based on the resource availability information, a peer-to-peer (P2P) registry of a plurality of enhanced edge services that can be performed during a P2P exchange using the processing resources of the plurality edge computing devices; detect an edge computing device of the plurality of edge computing devices is executing a P2P application associated with a set of services; and select an enhanced edge service from the plurality of enhanced edge services in the P2P registry to substitute at least one service of the set of services during the executing of the P2P application.

In Example 13, the subject matter of Example 12 includes, P application is one of a messaging application, a gaming application, and a video chat application.

In Example 14, the subject matter of Examples 12-13 includes subject matter where the set of services includes one or more of a compute service, an acceleration service, a high definition (HD) streaming service, a caching/storage service, and an encryption/decryption service.

In Example 15, the subject matter of Examples 12-14 includes subject matter where the instructions further configure the hardware components to perform operations to select the enhanced edge service to substitute the at least one service of the set of services based on a comparison of a performance indicator for the at least one service with a performance indicator for the enhanced edge service.

In Example 16, the subject matter of Example 15 includes subject matter where: the performance indicator for the at least one service is indicative of utilization of compute resources, storage resources, or acceleration resources of the edge computing device during execution of the at least one service; and the performance indicator for the enhanced edge service is indicative of utilization of compute resources, storage resources, or acceleration resources of the edge computing system that are external to the edge computing device.

In Example 17, the subject matter of Examples 12-16 includes subject matter where the instructions further configure the hardware components to perform operations to generate access credentials for the edge computing device, the access credentials to permit access to the processing resources for execution of the enhanced edge service in place of the at least one service.

Example 18 is at least one non-transitory machine.-readable storage device comprising instructions stored thereupon, which when executed by processing circuitry of an edge computing device operable in an edge computing system, cause the processing circuitry to perform operations comprising: receiving a request from a second edge computing device to perform a peer-to-peer (P2P) exchange; determining a set of services for execution by the processing circuitry during the P2P exchange with the second edge computing device; determining whether an enhanced edge service is available to substitute at least one service of the set of services, the enhanced edge service associated with processing resources of the edge computing system that are external to the edge computing device; and based on a successful determination that the enhanced edge service is available, utilizing the processing resources of the edge computing system that are external to the edge computing device to execute the enhanced edge service in place of the at least one service during the P2P exchange.

In Example 19, the subject matter of Example 18 includes subject matter where: the set of services are associated with a P2P application executing on the edge computing device during the P2P exchange; the P2P application is one of a messaging application, a gaming application, and a video chat application; and the set of services includes one or more of a compute service, an acceleration service, a caching/storage service, and an encryption/decryption service.

In Example 20, the subject matter of Examples 18-19 includes subject matter where each service of the set of services is associated with a performance indicator when executed by the processing circuitry of the edge computing device.

In Example 21, the subject matter of Example 20 includes subject matter where to determine the enhanced edge service is available, the instructions further cause the processing circuitry to perform operations comprising: accessing a P2P registry of a plurality of enhanced edge services associated with the processing resources of the edge computing system that are external to the edge computing device, the P2P registry maintained by an edge orchestration device.

In Example 22, the subject matter of Example 21 includes subject matter where to determine the enhanced edge service is available, the instructions further cause the processing circuitry to perform operations comprising: retrieving from the P2P registry, a performance indicator for each of the plurality of enhanced edge services; and selecting the enhanced edge service from the plurality of enhanced edge services to substitute the at least one service of the set of services based on a comparison of the performance indicators for the set of services with the performance indicators for the plurality of enhanced edge services.

In Example 23, the subject matter of Example 22 includes subject matter where each of the performance indicators for the set of services is indicative of utilization of compute resources, storage resources, or acceleration resources of the edge computing device during execution of a corresponding service of the set of services.

In Example 24, the subject matter of Examples 22-23 includes subject matter where each of the performance indicators for the plurality of enhanced edge services is indicative of utilization of compute resources, storage resources, or acceleration resources of the edge computing system that are external to the edge computing device, during execution of a corresponding service of the plurality of enhanced edge services.

In Example 25, the subject matter of Examples 22-24 includes subject matter where the instructions further cause the processing circuitry to perform operations comprising: performing a secure exchange with the edge orchestration device to obtain access credentials associated with the enhanced edge service selected from the plurality of enhanced edge services and utilizing the access credentials to access the processing resources of the edge computing system that are external to the edge computing device to execute the enhanced edge service in place of the at least one service during the P2P exchange.

Example 26 is at least one non-transitory machine-readable storage device comprising instructions stored thereupon, which when executed by processing circuitry of an orchestration system operable in an edge computing system, cause the processing circuitry to perform operations comprising: obtaining resource availability information for processing resources of a plurality of edge computing devices operable in an edge computing system; generating, based on the resource availability information, a peer-to-peer (P2P) registry of a plurality of enhanced edge services that can be performed during a P2P exchange using the processing resources of the plurality edge computing devices; detecting an edge computing device of the plurality of edge computing devices is executing a P2P application associated with a set of services; and selecting an enhanced edge service from the plurality of enhanced edge services in the P2P registry to substitute at least one service of the set of services during the executing of the P2P application.

In Example 27, the subject matter of Example 26 includes, P application is one of a messaging application, a gaming application, and a video chat application.

In Example 28, the subject matter of Examples 26-27 includes subject matter where the set of services includes a compute service.

In Example 29, the subject matter of Examples 26-28 includes subject matter where the set of services includes an acceleration service.

In Example 30, the subject matter of Examples 26-29 includes subject matter where the set of services includes a caching/storage service.

In Example 31, the subject matter of Examples 26-30 includes subject matter where the set of services includes an encryption/decryption service.

In Example 32, the subject matter of Examples 26-31 includes subject matter where the instructions further cause the processing circuitry to perform operations comprising: selecting the enhanced edge service to substitute the at least one service of the set of services based on a comparison of a performance indicator for the at least one service with a performance indicator for the enhanced edge service.

In Example 33, the subject matter of Example 32 includes subject matter where the performance indicator for the at least one service is indicative of utilization of compute resources of the edge computing device during execution of the at least one service.

In Example 34, the subject matter of Examples 32-33 includes subject matter where the performance indicator for the at least one service is indicative of utilization of storage resources of the edge computing device during execution of the at least one service.

In Example 35, the subject matter of Examples 32-34 includes subject matter where the performance indicator for the at least one service is indicative of utilization of acceleration resources of the edge computing device during execution of the at least one service.

In Example 36, the subject matter of Examples 32-35 includes subject matter where the performance indicator for the enhanced edge service is indicative of utilization of compute resources of the edge computing system that are external to the edge computing device.

In Example 37, the subject matter of Examples 32-36 includes subject matter where the performance indicator for the enhanced edge service is indicative of utilization of storage resources of the edge computing system that are external to the edge computing device.

In Example 38, the subject matter of Examples 32-37 includes subject matter where the performance indicator for the enhanced edge service is indicative of utilization of acceleration resources of the edge computing system that are external to the edge computing device.

In Example 39, the subject matter of Examples 26-38 includes subject matter where the instructions further cause the processing circuitry to perform operations comprising: generating access credentials for the edge computing device, the access credentials to permit access to the processing resources for execution of the enhanced edge service in place of the at least one service.

Example 40 is at least one machine-readable medium including instructions that, when executed by processing circuity, cause the processing circuitry to perform operations to implement any of Examples 1-39.

Example 41 is an apparatus comprising means to implement of any of Examples 1-39.

Example 42 is a system to implement any of Examples 1-39.

Example 43 is a method to implement any of Examples 1-39.

Example 44 is a multi-tier edge computing system, comprising a plurality of edge computing nodes provided among on-premise edge, network access edge, or near edge computing settings, the plurality of edge computing nodes configured to perform any of the methods of Examples 1-39.

Example 45 is an edge computing system, comprising a plurality of edge computing nodes, each of the plurality of edge computing nodes configured to perform any of the methods of Examples 1-39.

Example 46 is an edge computing node, operable in an edge computing system, comprising processing circuitry coupled to enhanced DMA circuitry configured to implement any of the methods of Examples 1-39.

Example 47 is an edge computing node, operable as a server hosting the service and a plurality of additional services in an edge computing system, configured to perform any of the methods of Examples 1-39.

Example 47 is an edge computing node, operable in a layer of an edge computing network as an aggregation node, network hub node, gateway node, or core data processing node, configured to perform any of the methods of Examples 1-39.

Example 49 is an edge provisioning, orchestration, or management node, operable in an edge computing system, configured to implement any of the methods of Examples 1-39.

Example 50 is an edge computing network, comprising networking and processing components configured to provide or operate a communications network, to enable an edge computing system to implement any of the methods of Examples 1-39.

Example 51 is an access point, comprising networking and processing components configured to provide or operate a communications network, to enable an edge computing system to implement any of the methods of Examples 1-39.

Example 52 is a base station, comprising networking and processing components configured to provide or operate a communications network, configured as an edge computing system to implement any of the methods of Examples 1-39.

Example 53 is a road-side unit, comprising networking components configured to provide or operate a communications network, configured as an edge computing system to implement any of the methods of Examples 1-39.

Example 54 is an on-premise server, operable in a private communications network distinct from a public edge computing network, configured as an edge computing system to implement any of the methods of Examples 1-39.

Example 55 is a 3GPP 4G/LTE mobile wireless communications system, comprising networking and processing components configured as an edge computing system to implement any of the methods of Examples 1-39.

Example 56 is a 5G network mobile wireless communications system, comprising networking and processing components configured as an edge computing system to implement any of the methods of Examples 1-39.

Example 57 is an edge computing system configured as an edge mesh, provided with a microservice cluster, a microservice cluster with sidecars, or linked microservice clusters with sidecars, configured to implement any of the methods of Examples 1-39.

Example 58 is an edge computing system, comprising circuitry configured to implement services with one or more isolation environments provided among dedicated hardware, virtual machines, containers, or virtual machines on containers, the edge computing system configured to implement any of the methods of Examples 1-39.

Example 59 is an edge computing system, comprising networking and processing components to communicate with a user equipment device, client computing device, provisioning device, or management device to implement any of the methods of Examples 1-39.

Example 60 is networking hardware with network functions implemented thereupon, operable within an edge computing system, the network functions configured to implement any of the methods of Examples 1-39.

Example 61 is acceleration hardware with acceleration functions implemented thereupon, operable in an edge computing system, the acceleration functions configured to implement any of the methods of Examples 1-39.

Example 62 is storage hardware with storage capabilities implemented thereupon, operable in an edge computing system, the storage hardware configured to implement any of the methods of Examples 1-39.

Example 63 is computation hardware with compute capabilities implemented thereupon, operable in an edge computing system, the computation hardware configured to implement any of the methods of Examples 1-39.

Example 64 is an edge computing system configured to implement services with any of the methods of Examples 1-39, with the services relating to one or more of: compute offload, data caching, video processing, network function virtualization, radio access network management, augmented reality, virtual reality, autonomous driving, vehicle assistance, vehicle communications, industrial automation, retail services, manufacturing operations, smart buildings, energy management, internet of things operations, object detection, speech recognition, healthcare applications, gaming applications, or accelerated content processing.

Example 65 is an apparatus of an edge computing system comprising: one or more processors and one or more computer-readable media comprising instructions that, when executed by the one or more processors, cause the one or more processors to perform any of the methods of Examples 1-39.

Example 66 is one or more computer-readable storage media comprising instructions to cause an electronic device of an edge computing system, upon execution of the instructions by one or more processors of the electronic device, to perform any of the methods of Examples 1-39.

Example 67 is a computer program used in an edge computing system, the computer program comprising instructions, wherein execution of the program by a processing element in the edge computing system is to cause the processing element to perform any of the methods of Examples 1-39.

Example 68 is an edge computing appliance device operating as a self-contained processing system, comprising a housing, case or shell, network communication circuitry, storage memory circuitry, and processor circuitry adapted to perform any of the methods of Examples 1-39.

Example 69 is an apparatus of an edge computing system comprising means to perform any of the methods of Examples 1-39.

Example 70 is an apparatus of an edge computing system comprising logic, modules, or circuitry to perform any of the methods of Examples 1-39.

Another example implementation is an edge computing system, including respective edge processing devices and nodes to invoke or perform the operations of Examples 1-39, or other subject matter described herein.

Another example implementation is a client endpoint node, operable to invoke or perform the operations of Examples 1-39, or other subject matter described herein.

Another example implementation is an aggregation node, network hub node, gateway node, or core data processing node, within or coupled to an edge computing system, operable to invoke or perform the operations of Examples 1-39, or other subject matter described herein.

Another example implementation is an access point, base station, road-side unit, street-side unit, or on-premise unit, within or coupled to an edge computing system, operable to invoke or perform the operations of Examples 1-39, or other subject matter described herein.

Another example implementation is an edge provisioning node, service orchestration node, application orchestration node, or multi-tenant management node, within or coupled to an edge computing system, operable to invoke or perform the operations of Examples 1-39, or other subject matter described herein.

Another example implementation is an edge node operating an edge provisioning service, application or service orchestration service, virtual machine deployment, container deployment, function deployment, and compute management, within or coupled to an edge computing system, operable to invoke or perform the operations of Examples 1-39, or other subject matter described herein.

Another example implementation is an edge computing system including aspects of network functions, acceleration functions, acceleration hardware, storage hardware, or computation hardware resources, operable to invoke or perform the use cases discussed herein, with use of Examples 1-39, or other subject matter described herein.

Another example implementation is an edge computing system adapted for supporting client mobility, vehicle-to-vehicle (V2V), vehicle-to-everything (V2X), or vehicle-to-infrastructure (V2I) scenarios, and optionally operating according to European Telecommunications Standards Institute (ETSI) Multi-Access Edge Computing (MEC) specifications, operable to invoke or perform the use cases discussed herein, with use of Examples 1-39, or other subject matter described herein.

Another example implementation is an edge computing system adapted for mobile wireless communications, including configurations according to a 3GPP 4G/LTE or 5G network capabilities, operable to invoke or perform the use cases discussed herein, with use of Examples 1-39, or other subject matter described herein.

Another example implementation is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of Examples 1-39, or other subject matter described herein.

Another example implementation is networking hardware, acceleration hardware, storage hardware, or computation hardware, with capabilities implemented thereupon, operable in an edge computing system to invoke or perform the use cases discussed herein, with use of Examples 1-39, or other subject matter described herein.

Another example implementation is an apparatus of an edge computing system comprising: one or more processors and one or more computer-readable media comprising instructions that, when deployed and executed by the one or more processors, cause the one or more processors to invoke or perform the use cases discussed herein, with use of Examples 1-39, or other subject matter described herein.

Another example implementation is one or more computer-readable storage media comprising instructions to cause an electronic device of an edge computing system, upon execution of the instructions by one or more processors of the electronic device, to invoke or perform the use cases discussed herein, with use of Examples 1-39, or other subject matter described herein.

Another example implementation is an apparatus of an edge computing system comprising means, logic, modules, or circuitry to invoke or perform the use cases discussed herein, with the use of Examples 1-39, or other subject matter described herein.

Although these implementations have been described with reference to specific exemplary aspects, it will be evident that various modifications and changes may be made to these aspects without departing from the broader scope of the present disclosure. Many of the arrangements and processes described herein can be used in combination or parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is disclosed. Thus, although specific aspects have been illustrated and described herein, it should be appreciated that any arrangement calculated to achieve the same purpose may be substituted for the specific aspects shown. This disclosure is intended to cover any adaptations or variations of various aspects. Combinations of the above aspects and other aspects not specifically described herein will be apparent to those of skill in the art upon reviewing the above description.

What is claimed is:

1. An edge computing device operable in an edge computing system, the edge computing device comprising:
network communications circuitry (NCC);
a memory device; and
processing circuitry coupled to the NCC and the memory device, the processing circuitry configured to:
receive a request from a second edge computing device via the NCC, to perform a peer-to-peer (P2P) exchange;
determine a set of services for execution by the processing circuitry during the P2P exchange with the second edge computing device;
determine whether an enhanced edge service is available to substitute at least one service of the set of services, the enhanced edge service associated with processing resources of the edge computing system that are external to the edge computing device; and
based on a successful determination that the enhanced edge service is available, utilize the processing resources of the edge computing system that are external to the edge computing device to execute the enhanced edge service in place of the at least one service during the P2P exchange.

2. The edge computing device of claim 1, wherein the set of services are associated with a P2P application executing on the edge computing device during the P2P exchange, and wherein the P2P application is one of:
a messaging application;
a gaming application; and
a video chat application.

3. The edge computing device of claim 1, wherein the set of services includes one or more of:
a compute service;
an acceleration service;
a high definition (HD) streaming service;
a caching/storage service; and
an encryption/decryption service.

4. The edge computing device of claim 1, wherein each service of the set of services is associated with a performance indicator when executed by the processing circuitry of the edge computing device.

5. The edge computing device of claim 4, wherein to determine the enhanced edge service is available, the processing circuitry is configured to:
access a P2P registry of a plurality of enhanced edge services associated with the processing resources of the edge computing system that are external to the edge computing device, the P2P registry maintained by an edge orchestration device.

6. The edge computing device of claim 5, wherein to determine the enhanced edge service is available, the processing circuitry is configured to:
retrieve from the P2P registry, a performance indicator for each of the plurality of enhanced edge services; and
select the enhanced edge service from the plurality of enhanced edge services to substitute the at least one service of the set of services based on a comparison of the performance indicators for the set of services with the performance indicators for the plurality of enhanced edge services.

7. The edge computing device of claim 6, wherein each of the performance indicators for the set of services is indicative of utilization of compute resources, storage resources, or acceleration resources of the edge computing device during execution of a corresponding service of the set of services.

8. The edge computing device of claim 6, wherein each of the performance indicators for the plurality of enhanced edge services is indicative of utilization of compute resources, storage resources, or acceleration resources of the edge computing system that are external to the edge computing device, during execution of a corresponding service of the plurality of enhanced edge services.

9. The edge computing device of claim 6, wherein the processing circuitry is configured to:
perform a secure exchange with the edge orchestration device via the NCC to obtain access credentials associated with the enhanced edge service selected from the plurality of enhanced edge services.

10. The edge computing device of claim 9, wherein the processing circuitry is configured to:
utilize the access credentials to access the processing resources of the edge computing system that are external to the edge computing device to execute the enhanced edge service in place of the at least one service during the P2P exchange.

11. The edge computing device of claim 10, wherein the processing resources of the edge computing system that are external to the edge computing device are at least one of hardware resources and software resources of the edge orchestration device or a third edge computing device within the edge computing system.

12. An orchestration system comprising:
a plurality of hardware components, including a processing circuitry, network communications circuitry, and access credentials generating circuitry; and
at least one memory device including instructions embodied thereon, wherein the instructions, which when executed by the processing circuitry, configure the hardware components to perform operations to:
obtain resource availability information for processing resources of a plurality of edge computing devices operable in an edge computing system;
generate, based on the resource availability information, a peer-to-peer (P2P) registry of a plurality of enhanced edge services that can be performed during a P2P exchange using the processing resources of the plurality edge computing devices;
detect an edge computing device of the plurality of edge computing devices is executing a P2P application associated with a set of services; and
select an enhanced edge service from the plurality of enhanced edge services in the P2P registry to substitute at least one service of the set of services during the executing of the P2P application.

13. The orchestration system of claim 12, wherein the P2P application is one of a messaging application, a gaming application, and a video chat application.

14. The orchestration system of claim 12, wherein the set of services includes one or more of a compute service, an acceleration service, a high definition (HD) streaming service, a caching/storage service, and an encryption/decryption service.

15. The orchestration system of claim 12, wherein the instructions further configure the hardware components to perform operations to:
select the enhanced edge service to substitute the at least one service of the set of services based on a comparison of a performance indicator for the at least one service with a performance indicator for the enhanced edge service.

16. The orchestration system of claim 15, wherein:
the performance indicator for the at least one service is indicative of utilization of compute resources, storage resources, or acceleration resources of the edge computing device during execution of the at least one service; and
the performance indicator for the enhanced edge service is indicative of utilization of compute resources, storage resources, or acceleration resources of the edge computing system that are external to the edge computing device.

17. The orchestration system of claim 12, wherein the instructions further configure the hardware components to perform operations to:
generate access credentials for the edge computing device, the access credentials to permit access to the processing resources for execution of the enhanced edge service in place of the at least one service.

18. At least one non-transitory machine-readable storage device comprising instructions stored thereupon, which when executed by processing circuitry of an edge computing device operable in an edge computing system, cause the processing circuitry to perform operations comprising:
receiving a request from a second edge computing device to perform a peer-to-peer (P2P) exchange;
determining a set of services for execution by the processing circuitry during the P2P exchange with the second edge computing device;
determining whether an enhanced edge service is available to substitute at least one service of the set of services, the enhanced edge service associated with processing resources of the edge computing system that are external to the edge computing device; and
based on a successful determination that the enhanced edge service is available, utilizing the processing resources of the edge computing system that are external to the edge computing device to execute the enhanced edge service in place of the at least one service during the P2P exchange.

19. The machine-readable storage device of claim 18, wherein:
the set of services are associated with a P2P application executing on the edge computing device during the P2P exchange;
the P2P application is one of a messaging application, a gaming application, and a video chat application; and
the set of services includes one or more of a compute service, an acceleration service, a caching/storage service, and an encryption/decryption service.

20. The machine-readable storage device of claim 18, wherein each service of the set of services is associated with a performance indicator when executed by the processing circuitry of the edge computing device.

21. The machine-readable storage device of claim 20, wherein to determine the enhanced edge service is available, the instructions further cause the processing circuitry to perform operations comprising:
accessing a P2P registry of a plurality of enhanced edge services associated with the processing resources of the edge computing system that are external to the edge computing device, the P2P registry maintained by an edge orchestration device.

22. The machine-readable storage device of claim 21, wherein to determine the enhanced edge service is available, the instructions further cause the processing circuitry to perform operations comprising:
retrieving from the P2P registry, a performance indicator for each of the plurality of enhanced edge services; and
selecting the enhanced edge service from the plurality of enhanced edge services to substitute the at least one service of the set of services based on a comparison of the performance indicators for the set of services with the performance indicators for the plurality of enhanced edge services.

23. The machine-readable storage device of claim 22, wherein each of the performance indicators for the set of services is indicative of utilization of compute resources, storage resources, or acceleration resources of the edge computing device during execution of a corresponding service of the set of services.

24. The machine-readable storage device of claim 22, wherein each of the performance indicators for the plurality of enhanced edge services is indicative of utilization of compute resources, storage resources, or acceleration resources of the edge computing system that are external to the edge computing device, during execution of a corresponding service of the plurality of enhanced edge services.

25. The machine-readable storage device of claim 22, wherein the instructions further cause the processing circuitry to perform operations comprising:
performing a secure exchange with the edge orchestration device to obtain access credentials associated with the enhanced edge service selected from the plurality of enhanced edge services; and
utilizing the access credentials to access the processing resources of the edge computing system that are external to the edge computing device to execute the enhanced edge service in place of the at least one service during the P2P exchange.

26. At least one non-transitory machine-readable storage device comprising instructions stored thereupon, which when executed by processing circuitry of an orchestration system operable in an edge computing system, cause the processing circuitry to perform operations comprising:
obtaining resource availability information for processing resources of a plurality of edge computing devices operable in an edge computing system;
generating, based on the resource availability information, a peer-to-peer (P2P) registry of a plurality of enhanced edge services that can be performed during a P2P exchange using the processing resources of the plurality edge computing devices;
detecting an edge computing device of the plurality of edge computing devices is executing a P2P application associated with a set of services; and
selecting an enhanced edge service from the plurality of enhanced edge services in the P2P registry to substitute at least one service of the set of services during the executing of the P2P application.

27. The machine-readable storage device of claim 26, wherein the P2P application is one of a messaging application, a gaining application, and a video chat application.

28. The machine-readable storage device of claim 26, wherein the set of services includes a compute service.

29. The machine-readable storage device of claim 26, wherein the set of services includes an acceleration service.

30. The machine-readable storage device of claim 26, wherein the set of services includes a caching/storage service.
